(19) United States
(12) Patent Application Publication
(10) Pub. No.: US 2009/0268301 A1
(43) Pub. Date: Oct. 29, 2009

(54) FLAT PANEL DISPLAY AND ANTIGLARE FILM FOR FLAT PANEL DISPLAY

(75) Inventors: Naoto OOE, Ibaraki-shi (JP); Taku YAMADA, Ibaraki-shi (JP); Tatsuki NAGATSUKA, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/431,183

(22) Filed: Apr. 28, 2009

(30) Foreign Application Priority Data
Apr. 28, 2008 (JP) 2008-117282

(51) Int. Cl. G02B 1/11

(52) U.S. Cl. 359/601

(57) ABSTRACT

A flat panel display is provided that increases visibility without deteriorating the properties of flat panel displays such as LCDs with increased variation in definition or the like. Further, an antiglare film is provided that is used for the flat panel display. A flat panel display includes an antiglare film at a viewing side surface thereof. The flat panel display includes a black matrix pattern. An aperture ratio A (%) of the black matrix pattern, an average interval Sm (mm) between concaves and convexes of a surface of the antiglare film, and a haze H (%) satisfy a relationship of the following Formula (1), and the total haze value is 15 or less.

A>(100Sm−0.142H+5.1)/0.26 (1)
Sm: average interval (mm) between concaves and convexes of surface measured according to JIS B 0601 (1994 version)

### CROSS-REFERENCE TO RELATED APPLICATIONS

This application claims priority from Japanese Patent Application No. 2008-117282 filed on Apr. 28, 2008 the entire contents of which are hereby incorporated by reference.

### BACKGROUND OF THE INVENTION

1. Field of the Invention

The present invention relates to flat panel displays and antiglare films for flat panel displays.

2. Description of the Related Art

With technical improvements in recent years, liquid crystal displays (LCDs), plasma display panels (PDPs), electroluminescence displays (ELDs), etc. have been developed in addition to conventional cathode ray tube (CRT) displays as image displays and have been used in practical applications. The surface of the image display is subjected to an antiglare treatment for preventing a decrease in contrast due to reflection of outside light such as fluorescent light and sunlight as well as reflection of an image at the surface of the image display. Particularly, with an increase in size of the screens of image displays, the number of image displays equipped with antiglare films is increasing.

Recently, in order to improve image quality, the number of high definition image displays with small pixel sizes is increasing. In such high definition image displays, when a conventional antiglare film is disposed, variations in luminance in pixels are emphasized further more to cause a visible failure (a failure due to glare) to result in considerably deteriorated image quality. Conventionally, in order to respond to the high definition image display, a method is proposed for eliminating glare using an internal scatter by adding fine particles to the antiglare film (see, for instance, JP 2001-305314 A and JP 3743624 B). However, use of the internal scatter for eliminating glare causes unclearness in displayed image and decrease in contrast. Further, there are variety of sizes of image displays in accordance with applications and sizes and forms of pixels thereof are of great variety. Therefore, an antiglare film, in which contrast is not decreased and glare is not generated in accordance with each image display, is desired.

### SUMMARY OF THE INVENTION

The present invention is intended to provide a flat panel display that increases visibility without deteriorating the properties of flat panel displays such as LCDs with increased variation in definition or the like. That is, the present invention is intended to provide a flat panel display having an antiglare film that is excellent in antiglare properties, small in glare, small in decrease in contrast, and suitable for the panel. Further, the present invention is intended to provide an antiglare film used for the flat panel display.

In order to achieve the aforementioned object, the flat panel display of the present invention is one including an antiglare film at a viewing side surface thereof, wherein the flat panel display includes a black matrix pattern,

where an aperture ratio A (%) of the black matrix pattern, the following average interval Sm (mm) between concaves and convexes of a surface of the antiglare film, and the following surface haze H (%) satisfy a relationship of the following Formula (1), and the following total haze value is 15 or less.

A>(100Sm−0.142H+5.1)/0.26 (1)
Sm: average interval (mm) between concaves and convexes of surface measured according to Japanese Industrial Standards (JIS) B 0601 (1994 version)
Surface haze H: total haze value−inner haze value
Total haze value: haze value (cloudiness) (%) of whole antiglare film based on JIS K 7136 (2000 version)
Inner haze value: haze value of whole antiglare film measured in a case where surface of antiglare film is smoothed

The antiglare film for a flat panel display of the present invention is one attached to a viewing side surface of the flat panel display, wherein the flat panel display includes a black matrix pattern,

where according to an aperture ratio A (%) of the black matrix pattern, the following average interval Sm (mm) between concaves and convexes of a surface of the antiglare film and the following surface haze H (%) are designated so as to satisfy a relationship of the following Formula (1),

and the following total haze value is 15 or less.

A>(100Sm−0.142H+5.1)/0.26 (1)
Sm: average interval (mm) between concaves and convexes of surface measured according to JIS B 0601 (1994 version)
Surface haze H: total haze value−inner haze value
Total haze value: haze value (cloudiness) (%) of whole antiglare film based on JIS K 7136 (2000 version)
Inner haze value: haze value of whole antiglare film measured in a case where surface of antiglare film is smoothed

The flat panel display of the present invention is one comprising an antiglare film at a viewing side surface thereof, wherein the antiglare film is an antiglare film for a flat panel display of the present invention.

The flat panel display of the present invention makes it possible to increase visibility without deteriorating the properties of flat panel displays such as LCDs with increased variation in definition or the like. That is, the present invention can provide a flat panel display having an antiglare film that is excellent in antiglare properties, small in glare, small in decrease in contrast, and suitable for the panel. Further, the present invention can provide an antiglare film used for the flat panel display in accordance with the panel. Therefore, the flat panel display having an antiglare film for the flat panel display is excellent in display properties.

### BRIEF DESCRIPTION OF THE DRAWINGS

FIG. 1 is a sectional schematic view showing a structure of an example of the antiglare film for a flat panel display of the present invention.

FIG. 2 is a sectional schematic view showing a structure of another example of the antiglare film for a flat panel display of the present invention.

FIG. 3 is a schematic view for explaining a method of manufacturing the antiglare film for a flat panel display according to a preferable embodiment of the present invention.

FIG. 4 is a sectional schematic view for explaining a measurement method of an inner haze value in Examples and Comparative Examples.

FIG. 5 is a schematic view for explaining a measurement method of glare in Examples and Comparative Examples.

FIGS. 6 (a)-(d) are examples of images that show an analysis method of variation in luminance in a glare measurement in Examples and Comparative Examples; FIG. 6 (a) is an image after 12-bit grayscale conversion, FIG. 6 (b) is an image after fast Fourier transformation, FIG. 6 (c) is an image after high-frequency removal, FIG. 6 (d) is an image after inverse Fourier transformation, and FIG. 6 (e) is a histogram analysis data of the image after inverse Fourier transformation.

FIGS. 7 (a)-(d) are photographs of mask patterns used for the glare measurement in Examples and Comparative Examples.

### DETAILED DESCRIPTION OF THE INVENTION

In the flat panel display of the present invention, it is preferable that the antiglare film does not contain fine particles with a weight average particle size of 50 nm or more.

In the flat panel display of the present invention, it is preferable that a decreasing ratio of a contrast of the flat panel display relative to a contrast of the flat panel display measured after removing the antiglare film therefrom is less than 10%.

In the flat panel display of the present invention, it is preferable that the Sm (mm) of the antiglare film is in a range of 0.01<Sm<0.5.

In the flat panel display of the present invention, it is preferable that the following Ra (μm) of the antiglare film is in a range of 0.01<Ra<0.5.
Ra: arithmetic average surface roughness (μm) defined by JIS B 0601 (1994 version)

In the flat panel display of the present invention, it is preferable that an uneven shape of the surface of the antiglare film is formed by embossing.

In the antiglare film for a flat panel display of the present invention, it is preferable that the antiglare film does not contain fine particles with a weight average particle size of 50 nm or more.

In the antiglare film for a flat panel display of the present invention, it is preferable that the Sm (mm) of the antiglare film is in a range of 0.01<Sm<0.5.

In the antiglare film for a flat panel display of the present invention, it is preferable that the following Ra (μm) of the antiglare film is in a range of 0.01<Ra<0.5.
Ra: arithmetic average surface roughness (μm) defined by JIS B 0601 (1994 version)

In the antiglare film for a flat panel display of the present invention, it is preferable that an uneven shape of the surface of the antiglare film is formed by embossing.

Next, the present invention is described in detail. However, the present invention is not limited by the following descriptions.

The antiglare film provided at a viewing side surface of the flat panel display of the present invention and the antiglare film for a flat panel display of the present invention include an antiglare layer formed on at least one surface of a transparent plastic film substrate, for example.

The transparent plastic film substrate is not particularly limited. Preferably, the transparent plastic film substrate has a high visible light transmittance (preferably a light transmittance of at least 90%) and good transparency (preferably a haze value of 1% or lower). Examples of the material for forming the transparent plastic film substrate include polyester type polymers such as polyethylene terephthalate (PET) and polyethylene naphthalate, cellulose type polymers such as diacetyl cellulose and triacetyl cellulose (TAC), polycarbonate type polymers, and acrylics type polymers such as polymethylmethacrylate. Examples of the material for forming the transparent plastic film substrate also include styrene type polymers such as polystyrene and an acrylonitrile-styrene copolymer, olefin type polymers such as polyethylene, polypropylene, polyolefin that has a cyclic or norbornene structure, and an ethylene-propylene copolymer, vinyl chloride type polymers, and amide type polymers such as nylon and aromatic polyamide. Furthermore, examples of the material for forming the transparent plastic film substrate also include imide type polymers, sulfone type polymers, polyether sulfone type polymers, polyether-ether ketone type polymers, polyphenylene sulfide type polymers, vinyl alcohol type polymers, vinylidene chloride type polymers, vinyl butyral type polymers, allylate type polymers, polyoxymethylene type polymers, epoxy type polymers and blends of the above-mentioned polymers. Among them, those having small optical birefringence are used suitably. The antiglare film for a flat panel display of the present invention can be used, for example, as a protective film for a polarizing plate. In this case, the transparent plastic film substrate is preferably a film formed of TAC, polycarbonate, an acrylic polymer, or a polyolefin that has a cyclic or norbornene structure. In the present invention, as described below, the transparent plastic film substrate may be a polarizer itself. Such a structure does not require a protective layer formed of, for example, TAC and simplifies the structure of the polarizing plate. Accordingly, such a structure makes it possible to reduce the number of steps for manufacturing polarizing plates or image displays and to increase production efficiency. In addition, such a structure allows polarizing plates to be formed of thinner layers. When the transparent plastic film substrate is a polarizer, the antiglare layer serves as a conventional protective layer. In such a structure, the antiglare film for a flat panel display also functions as a cover plate in a case where it is attached to the surface of a liquid crystal cell, for example.

The thickness of the transparent plastic film substrate is not particularly limited. For example, the thickness is preferably in the range of 10 to 500 μm, more preferably in the range of 20 to 300 μm, and most suitably in the range of 30 to 200 μm, with consideration given to strength, workability such as handling properties, and thin layer properties. The refractive index of the transparent plastic film substrate is not particularly limited. The refractive index is, for example, in the range of 1.30 to 1.80 and preferably in the range of 1.40 to 1.70.

The antiglare layer is formed using the material for forming the antiglare layer. Examples of the material for forming the antiglare layer include thermosetting resin and ionizing radiation curable resin that is cured with ultraviolet rays or light. Among these, the ultraviolet curable resin that allows an antiglare layer to be formed efficiently by a simple processing operation, namely a curing treatment using ultraviolet irradiation, is used particularly preferable. In this case, an ultraviolet polymerization initiator (photopolymerization initiator) is mixed into the ultraviolet curable resin.

Examples of the ultraviolet curable resin include those of various types such as a polyester type, acrylic type, urethane type, silicone type, and epoxy type. Examples of this ultraviolet curable resin include ultraviolet curable monomers, oligomers, and polymers. Examples of the ultraviolet curable resin that is particularly preferably used include those each having an ultraviolet polymerizable functional group, particularly, those containing acrylic type monomers or oligomers having at least two of the functional groups, particularly, three to six of them.

Specific examples of such an ultraviolet curable resin include acrylate resin of, for example, acrylic ester of polyhydric alcohol, methacrylate resin of, for example, methacrylic ester of polyhydric alcohol, polyfunctional urethane acrylate resin that is synthesized from diisocyanate, polyhydric alcohol, and hydroxyalkyl ester of acrylic acid, and polyfunctional urethane methacrylate resin that is synthesized from, for example, polyhydric alcohol and hydroxy methacrylic ester of methacrylic acid. Furthermore, for example, polyether resin, polyester resin, epoxy resin, alkyd resin, spiroacetal resin, polybutadiene resin, or polythiolpolyene resin, which has an acrylate type functional group, also can be used suitably as required. Moreover, for example, melamine type resin, urethane type resin, alkyd type resin, or silicone type resin also is used preferably.

Examples of the photopolymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N, N,N′,N′-tetramethyl-4,4′-diaminobenzophenone, 1-(4-isopropylphenyl)-2-hydroxy-2-methylpropane-1-one, and other thioxanthone compounds.

One of the above-mentioned resins may be used independently or two or more of them may be used in combination. Furthermore, it also is possible to use, for example, commercially available ultraviolet curable resin as the aforementioned resin.

With respect to the material for forming the antiglare layer, a refractive index of the antiglare layer is adjustable by containing fine particles with a weight average particle size of less than 50 nm, for example. From the viewpoints of, for example, preventing interference light from occurring at the interface between the transparent plastic film substrate and the antiglare layer, it is preferable that the difference in refractive index between the transparent plastic film substrate and the antiglare layer be reduced. The interference light causes a phenomenon in which reflected light of the outside light that has been incident on the antiglare film exhibits rainbow hue. Recently, three-wavelength fluorescent lamps with excellent clarity are used frequently in, for example, offices. The interference light appears conspicuously under the three-wavelength fluorescent lamps. Because of these points, in preparation of the material for forming the antiglare layer, it is preferable that components and amounts of the fine particles are adjusted such that the difference in the refractive index is reduced. When the material for forming the antiglare layer contains the fine particles with the average particle size of 50 nm or more, an inner haze of the antiglare layer increases and deterioration in the contrast tends to occur. Therefore, it is not preferable that the material for forming the antiglare layer contains fine particles with the average particle size of 50 nm or more.

The refractive index of the antiglare layer is preferably in the range of 1.40 to 1.65 and more preferably in the range of 1.45 to 1.59. The difference in refractive index between the transparent plastic film substrate and the antiglare layer is preferably 0.04 or less and more preferably 0.02 or less. Specifically, for example, in a case where a PET film (with a refractive index of about 1.64) is used as the transparent plastic film substrate, the difference in the refractive index can be controlled at 0.02 or less by using titanium oxide as the fine particle and blending it so that the amount of the titanium oxide becomes 30 to 40% by weight relative to the total resin component of the material for forming the antiglare layer. Thereby, occurrence of interference fringes can be prevented. Further, in a case where a TAC film (with a refractive index of about 1.48) is used as the transparent plastic film substrate, the difference in refractive index can be controlled at 0.02 or less by using silicon oxide (silica) as the fine particle and blending it so that the amount of the silicon oxide (silica) becomes 35 to 45% by weight relative to the total component of the material for forming the antiglare layer. Thereby, occurrence of interference fringes can be prevented.

The thickness of the antiglare layer is preferably in the range of 1 to 30 μm and further preferably in the range of 2 to 20 μm. When the thickness is within the aforementioned predetermined range, a desired uneven shape can be formed and mechanical strength of the antiglare layer can be ensured. Further, when the thickness exceeds the above-mentioned predetermined range, there are problems in that the antiglare layer curls considerably to have deteriorated line traveling performance during the coating. On the other hand, when the thickness is less than the aforementioned predetermined range, there are problems in that the hard-coating performance deteriorates.

The antiglare film for a flat panel display of the present invention has a total haze value of 15% or less. The aforementioned total haze value is a haze value (cloudiness) of a whole antiglare film according to JIS K 7136 (2000 version). The total haze value is preferably 10% or less. Preferably, the antiglare film for a flat panel display of the present invention has a low haze value in the range where antiglare performance is not deteriorated. In order to obtain the total haze value in the aforementioned range, it is preferable that the antiglare film for a flat panel display does not contain fine particles with a weight average particle size of 50 nm or more and that the antiglare film has an appropriate uneven shape on the surface thereof. The total haze value in the aforementioned range allows a clear image to be obtained and can improve the contrast in a dark place. When the total haze value is excessively low, a failure due to glare tends to occur. However, with respect to the antiglare film having a surface haze H that is designed in the range of the Formula (1) in accordance with a black matrix pattern of a flat panel display to which the antiglare film is attached, the glare can be prevented.

The surface haze H can be calculated by subtracting an inner haze value from a total haze value. In this state, the inner haze value is a haze value of a whole antiglare film measured in a condition where the surface of the antiglare film is smoothed. In order to form the smooth surface, for example, resins of the material for forming the antiglare layer may be applied to the surface of the antiglare film. By forming the smooth surface and measuring the haze value, a haze value (inner haze value) subtracting effect due to surface scattering component therefrom can be obtained.

In the antiglare film for a flat panel display of the present invention, the Sm (mm) is preferably in the range of 0.01<Sm<0.5 and more preferably in the range of 0.02<Sm<0.3 in the uneven shape of the surface of the antiglare layer. When the Sm exceeds 0.01 mm, white blur can be prevented and it is preferable. In order to reduce reflections of outside light and image at the surface of the antiglare film, it is preferable that the Sm is less than 0.5 mm.

In the antiglare film for a flat panel display of the present invention, an arithmetic average surface roughness Ra (μm) that is defined in JIS B 0601 (1994 version) is preferably in the range of 0.01<Ra<0.5 and more preferably in the range of 0.02<Ra<0.2 in the uneven shape of the surface of the antiglare layer. In order to prevent reflections of outside light and image at the surface of the antiglare film, a certain degree of surface roughness is required and an Ra of more than 0.01 μm allows the reflections to be reduced and is preferable. Furthermore, in order to prevent white blur from occurring, it is preferable that the Ra is less than 0.5 μm.

The antiglare film for a flat panel display of the present invention can be manufactured as follows. That is, for example, a material for forming an antiglare layer is prepared that contains solvent, the material for forming the antiglare layer is applied onto at least one surface of the transparent plastic film substrate to form a coating film, and the coating film is then cured to form the antiglare layer. In a case where the material for forming the antiglare layer is a liquid composition, the material for forming the antiglare layer can be applied to the transparent plastic film substrate to form a coating film without adding a solvent.

The solvent is not particularly limited and various solvents can be used. Examples of the solvent include dibutyl ether, dimethoxymethane, dimethoxyethane, diethoxyethane, propylene oxide, 1,4-dioxane, 1,3-dioxolane, 1,3,5-trioxane, tetrahydrofuran, acetone, methyl ethyl ketone (MEK), diethyl ketone, dipropyl ketone, diisobutyl ketone, cyclopentanone, cyclohexanone, methylcyclohexanone, ethyl formate, propyl formate, n-pentyl formate, methyl acetate, ethyl acetate, methyl propionate, ethyl propionate, n-pentyl acetate, acetyl acetone, diacetone alcohol, methyl acetoacetate, ethyl acetoacetate, methanol, ethanol, 1-propanol, 2-propanol, 1-butanol, 2-butanol, 1-pentanol, 2-methyl-2-butanol, cyclohexanol, isobutyl acetate, methyl isobutyl ketone (MIBK), 2-octanone, 2-pentanone, 2-hexanone, 2-heptanone, 3-heptanone, ethylene glycol monoethyl ether acetate, ethylene glycol monoethyl ether, ethylene glycol monobutyl ether, ethylene glycol monomethyl ether, propylene glycol monomethyl ether acetate, and propylene glycol monomethyl ether. One of these may be used independently or two or more of them may be used in combination.

Various types of leveling agents can be added to the material for forming the antiglare layer. The leveling agent may be, for example, a fluorine or silicone leveling agent, preferably a silicone leveling agent. Examples of the silicon leveling agent include a reactive silicone, polydimethylsiloxane, polyether-modified polydimethylsiloxane, and polymethylalkylsiloxane. Among these silicone leveling agents, the reactive silicone is particularly preferred. Addition of the reactive silicone can impart lubricity to the surface and maintain scratch resistance over a long period of time. In the case of using a reactive silicone containing a hydroxyl group, as described later, when an antireflection layer (a low refractive index layer) containing a siloxane component is formed on the antiglare layer, the adhesion between the antireflection layer and the antiglare layer is improved.

The amount of the leveling agent to be added is, for example, 5 parts by weight or less, preferably in the range of 0.01 to 5 parts by weight, per 100 parts by weight of the entire resin components.

If necessary, the material for forming the antiglare layer may contain, for example, a pigment, a filler, a dispersing agent, a plasticizer, an ultraviolet absorbing agent, a surfactant, an antifoulant, an antioxidant, or a thixotropy-imparting agent, as long as the performance is not impaired. One of these additives may be used independently or two or more of them may be used in combination.

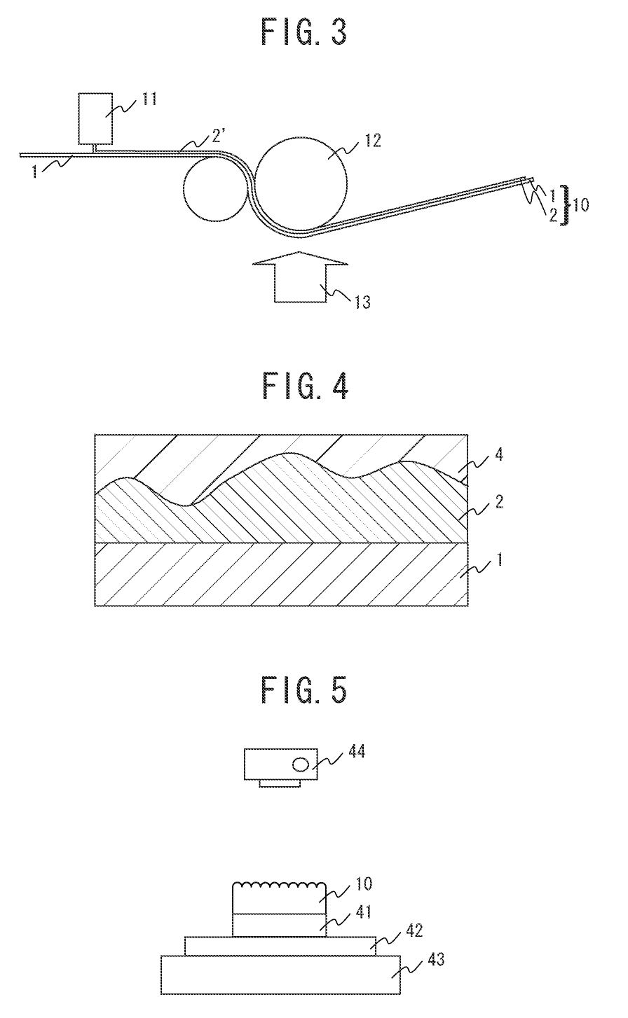

FIG. 3 is a schematic view for explaining a method of manufacturing the antiglare film according to a preferable embodiment of the present invention. First, a solution of the material for forming the antiglare layer is applied to a transparent plastic film substrate 1, which has been fed, to form a coating layer 2′. The material for forming the antiglare layer is as explained above. In a case where the material for forming the antiglare layer is a liquid component, it can be applied as it is. The material for forming the antiglare layer may be applied after adjusting viscosity thereof by diluting with a predetermined solvent or by adding a viscosity improver. By adjusting the viscosity of the material for forming the antiglare layer, the coating thickness is adjusted. As a result, the thickness of the antiglare layer can be adjusted. If necessary, a predetermined heating treatment may be carried out after coating to prevent or suppress the movement of the coating layer 2′. The heating temperature and the heating time can be adjusted suitably according to compositions of the material for forming the antiglare layer, types and amounts of the solvent, a viscosity of a coating liquid, and a desired thickness. The coating layer 2′ can directly be formed on the substrate 1 without requiring an adhesive layer. If necessary, a treatment for improving the adhesion between the substrate and the coating layer described later may be applied to the substrate 1.

In a coating means 11 of the material for forming the antiglare layer, an arbitrarily and suitable method can be adopted. Specifically, examples of the method include a coating method, a printing method, and the like. Examples of the coating method include an air doctor coating, a blade coating, a knife coating, a reverse coating, a transfer roll coating, a gravure roll coating, a kiss coating, a cast coating, a spray coating, a slot orifice coating, a calendar coating, an electrodeposition coating, a dip coating, a dye coating, etc. Examples of the printing method include an anastatic printing method such as a flexo printing method, an intaglio printing method such as a direct gravure printing method or an offset gravure printing method, a planographic printing method such as an offset printing method, a stencil printing method such as a screen printing method, etc.

Next, an uneven shape is formed on the surface of the coating layer 2′. Preferably, the uneven shape is formed by embossing. More specifically, an embossing is carried out by passing through a laminated body of the substrate 1 and the coating layer 2′ into an embossing roll 12. Use of the embossing roll 12 makes it possible to obtain the following advantages. That is:
(1) Since reproducibility of the uneven shape is considerably excellent as compared to a case where an uneven shape is formed by dispersing fine particles, variation in properties among antiglare films can remarkably be prevented.
(2) Since the surface of the embossing roll is processed and the shape thereof is transcribed onto the coating layer 2′, as compared to a case where the uneven shape is directly formed on the antiglare layer, the uneven shape according to the design can be formed and design for such uneven shape is very easy.
(3) Since the embossing can be applied to the laminated body, which is continuously fed, productivity is excellent.

Next, the coating layer 2′, to which the uneven shape is formed at the surface thereof, is completely cured by a curing means 13 to form an antiglare layer 2. Methods for curing and conditions of curing can suitably be selected in accordance with types of the material for forming the antiglare layer. However, thermal curing or ionizing radiation curing is preferable and ionizing radiation curing is more preferable. For example, when the material for forming the antiglare layer is an electron beam curable resin (for example, an ultraviolet curable resin), the coating layer 2′ may be irradiated with an electron beam (for example, an ultraviolet ray). Further, when the material for forming the antiglare layer is a thermosetting resin, the coating layer 2′ may be heated. In a case where the electron beam curable resin is used, if necessary, the coating layer may be applied with a heating treatment to evaporate the solvent after curing the coating layer by irradiating the electron beam thereto. Various types of activation energy can be used for the ionizing radiation curing method however ultraviolet ray is preferable. Preferred examples of the energy radiation source include radiation sources such as high-pressure mercury lamps, halogen lamps, xenon lamps, metal halide lamps, nitrogen lasers, electron beam accelerators, and radioactive elements. The amount of irradiation with the energy radiation source is preferably 50 to 5000 mJ/cm² in terms of accumulative exposure at an ultraviolet wavelength of 365 nm. When the amount of irradiation is at least 50 mJ/cm², the material can be cured more sufficiently and the resulting antiglare layer also has a further sufficiently high hardness. When the amount of irradiation is 5000 mJ/cm² or lower, the resulting antiglare layer can be prevented from being colored.

As described above, an antiglare film 10 including a transparent plastic film substrate 1 and an antiglare layer 2 can be obtained. In a case where the antiglare layer 2 is used independently, the transparent plastic film substrate 1 may be detached from the antiglare film 10. In such a case, an arbitrary and suitable detachment treatment may be applied to the substrate 1. The antiglare film for a flat panel display of the present invention may be manufactured by methods other than the aforementioned method.

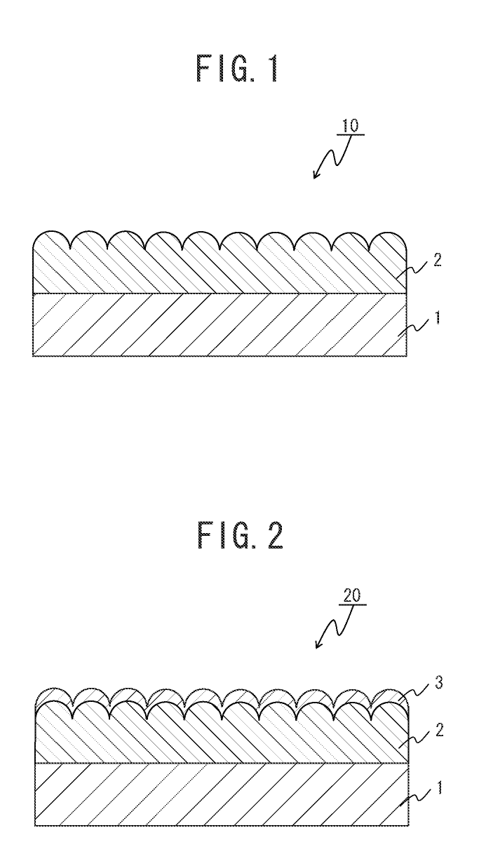

An example of the antiglare film for a flat panel display of the present invention is shown in a sectional schematic view of FIG. 1. As shown in FIG. 1, the antiglare film 10 of this example includes the antiglare layer 2 formed on one surface of the transparent plastic film substrate 1. The antiglare layer 2 includes an uneven shape at the surface thereof. In this example, the antiglare layer 2 is formed on one surface of the transparent plastic film substrate 1. However, the present invention is not limited thereto and the antiglare film may include the antiglare layers 2 formed on both surfaces of the transparent plastic film substrate 1. Further, the antiglare layer 2 in this example is a monolayer. However, the present invention is not limited thereto and the antiglare layer 2 may be a multilayer in which more than one layer is laminated.

In the antiglare film for a flat panel display of the present invention, an antireflection layer (a low refractive index layer) may be disposed on the antiglare layer. An example of the antiglare film for a flat panel display of the present invention that includes an antireflection layer is shown in a sectional schematic view of FIG. 2. As shown in FIG. 2, an antiglare film 20 in this example has a structure in which an antiglare layer 2 having an uneven shape at the surface thereof is formed on one surface of a transparent plastic film substrate 1 and an antireflection layer 3 is formed on the antiglare layer 2. Light that is incident on an object undergoes reflection at the interface, absorption and scattering in the interior, and any other phenomena repeatedly until it goes through the object and reaches the back side thereof. For example, light reflection at the interface between air and the antiglare layer is one of the factors that cause a reduction in visibility of images when an image display is equipped with the antiglare film. The antireflection layer reduces the surface reflection. In the antiglare film 20 shown in FIG. 2, the antiglare layer 2 and the antireflection layer 3 are formed on one surface of the transparent plastic film substrate 1. However, the present invention is not limited thereto and the antiglare layer 2 and the antireflection layer 3 may be formed on both surfaces of the transparent plastic film substrate 1. Further, in the antiglare film shown in FIG. 2, the antiglare layer 2 and the antireflection layer 3 are a monolayer. However, the present invention is not limited thereto and the antiglare layer 2 and the antireflection layer 3 may be a multilayer in which more than one layer is laminated.

In the present invention, the antireflection layer is preferably a thin optical film having a strictly controlled thickness and refractive index, or a laminate including at least two layers of the thin optical films that are laminated together. In the antireflection layer, the antireflection function is produced by allowing opposite phases of incident light and reflected light to cancel each other out by using the effect of interference of light. The wavelength range of visible light that allows the antireflection function to be produced is, for example, 380 to 780 nm, and the wavelength range in which the visibility is particularly high is in the range of 450 to 650 nm. Preferably, the antireflection layer is designed to have a minimum reflectance at the center wavelength 550 nm of the range.

When the antireflection layer is designed based on the effect of interference of light, the interference effect can be enhanced by, for example, a method of increasing the difference in refractive index between the antireflection layer and the antiglare layer. Generally, in an antireflection multilayer having a structure including two to five thin optical layers (each with strictly controlled thickness and refractive index) that are laminated together, components with different refractive indices from each other are used to form a plurality of layers with a predetermined thickness. Thus, the antireflection layer can be optically designed at a higher degree of freedom, the antireflection effect can be enhanced, and the spectral reflection characteristics also can be made even (flat) in the visible light range. Since each layer of the thin optical film must be precise in thickness, a dry process such as vacuum deposition, sputtering, or CVD is generally used to form each layer.

For the antireflection multilayer, one with a two-layer structure is preferred, in which a low refractive index silicon oxide layer (with a refractive index of about 1.45) is laminated on a high refractive index titanium oxide layer (with a refractive index of about 1.8). One with a four-layer structure is more preferable, in which a silicon oxide layer is laminated on a titanium oxide layer, another titanium oxide layer is laminated thereon, and then another silicon oxide layer is laminated thereon. The formation of the two- or four-layered antireflection layer can evenly reduce reflection over the visible light wavelength range (for example, in the range of 380 to 780 nm).

The antireflection effect can also be produced by forming a thin monolayer optical film (an antireflection layer) on the antiglare layer. The antireflection monolayer is generally formed using a coating method such as a wet process, for example, a fountain coating, a die coating, a spin coating, a spray coating, a gravure coating, a roll coating, or a bar coating.

Examples of the material for forming an antireflection monolayer include: resin materials such as ultraviolet curable acrylic resins; hybrid materials such as a dispersion of inorganic fine particles such as colloidal silica in a resin; and sol-gel materials containing metal alkoxide such as tetraethoxysilane and titanium tetraethoxide. Preferably, the material contains a fluorine group in order to impart anti-fouling surface properties. In terms of, for example, scratch resistance, the material preferably contains a large amount of an inorganic component, and the sol-gel materials are more preferable. The sol-gel materials can be used after being condensed partially.

The antireflection layer (the low refractive index layer) may contain an inorganic sol in order to increase film strength. The inorganic sol is not particularly limited and examples thereof include inorganic sols of, for example, silica, alumina, and magnesium fluoride. Particularly, silica sol is preferred. The amount of the inorganic sol to be added is, for example, in the range of 10 to 80 parts by weight, per 100 parts by weight of the total solids of the material for forming the antireflection layer. The size of the inorganic fine particles in the inorganic sol is preferably in the range of 2 to 50 nm and more preferably in the range of 5 to 30 nm.

The material for forming the antireflection layer preferably contains hollow spherical silicon oxide ultrafine particles. The silicon oxide ultrafine particles have preferably an average particle size of about 5 to 300 nm and more preferably in the range of 10 to 200 nm. The silicon oxide ultrafine particles are, for example, in the form of hollow spheres each including a pore-containing outer shell in which a hollow is formed. The hollow contains at least one of a solvent and a gas that has been used for preparing the silicon oxide ultrafine particles. A precursor substance for forming the hollow of the silicon oxide ultrafine particle preferably remains in the hollow. The thickness of the outer shell is preferably in the range of about 1 to 50 nm and in the range of approximately 1/50 to ⅕ of the average particle size of the silicon oxide ultrafine particles. Preferably, the outer shell is formed of a plurality of coating layers. In the silicon oxide ultrafine particles, it is preferable that the pore be blocked and the hollow be sealed with the outer shell. This is because the antireflection layer maintains a porous structure or a hollow of the silicon oxide ultrafine particles and therefore can have a further reduced refractive index. The method of manufacturing such hollow spherical silicon oxide ultrafine particles is preferably, for example, a method of manufacturing silica fine particles disclosed in JP 2001-233611 A.

The temperature for drying and curing that is employed in forming the antireflection layer (the low-refractive-index layer) is not particularly limited and is, for example, in the range of 60 to 150° C. and preferably in the range of 70 to 130° C. The period of time for drying and curing is, for instance, in the range of 1 to 30 minutes and preferably in the range of 1 to 10 minutes in view of productivity. After drying and curing, the layer is further heat-treated, so that an antiglare film of high hardness including an antireflection layer can be obtained. The temperature for the heating treatment is not particularly limited and is, for example, in the range of 40 to 130° C. and preferably in the range of 50 to 100° C. The period of time for the heating treatment is not particularly limited and is, for instance, 1 minute to 100 hours and more preferably at least 10 hours in terms of improving scratch resistance. The heating treatment can be performed by a method using, for example, a hot plate, an oven, or a belt furnace.

When the antiglare film including the antireflection layer is attached to an image display, the antireflection layer may frequently serve as the outermost surface and thus is susceptible to stains from the external environment. Stains are more conspicuous on the antireflection layer than on, for instance, a simple transparent plate. In the antireflection layer, for example, deposition of stains such as fingerprints, thumbmarks, sweat, and hair dressing products may change the surface reflectance, or the deposition may seem to stand out whitely to make the displayed content unclear. Preferably, an antistain layer formed of, for example, a fluoro-silane compound or a fluoro-organic compound is laminated on the antireflection layer in order to prevent deposition of stains and improve the ease of elimination of the stains deposited.

With respect to the antiglare film for a flat panel display of the present invention, it is preferable that at least one of the transparent plastic film substrate and the antiglare layer be subjected to a surface treatment. When the transparent plastic film substrate is subjected to the surface treatment, adhesion thereof to the antiglare layer further improves. When the antiglare layer is subjected to the surface treatment, adhesion thereof to the antireflection layer further improves. The surface treatment can be, for example, a low-pressure plasma treatment, an ultraviolet radiation treatment, a corona treatment, a flame treatment, or an acid or alkali treatment. When a triacetyl cellulose film is used for the transparent plastic film substrate, the surface treatment is preferably an alkali treatment. This alkali treatment can be carried out as follows. That is, after being brought into contact with an alkali solution, the surface of the triacetyl cellulose film is washed with water and is then dried. The alkali solution can be, for example, a potassium hydroxide solution or a sodium hydroxide solution. The normal concentration of the hydroxide ions of the alkali solution is preferably in the range of 0.1 to 3.0 N (mol/L) and more preferably in the range of 0.5 to 2.0 N (mol/L).

In an antiglare film including the transparent plastic film substrate and the antiglare layer formed on one surface of the transparent plastic film substrate, in order to prevent curling, the other surface may be subjected to a solvent treatment. The solvent treatment can be carried out by bringing the transparent plastic film substrate into contact with a dissolvable or swellable solvent. The solvent treatment also imparts a tendency to curl to the other surface. This can cancel a tendency to curl that is caused by formation of the antiglare layer, and thus can prevent curling. Similarly, in the antiglare film including the transparent plastic film substrate and the antiglare layer formed on one surface of the transparent plastic film substrate, in order to prevent curling, a transparent resin layer may be formed on the other surface. The transparent resin layer can be, for example, a layer that is composed mainly of a thermoplastic resin, a radiation-curable resin, a thermo-setting resin, or any other reactive resin. Particularly, a layer composed mainly of a thermoplastic resin is preferred.

The transparent plastic film substrate side of the antiglare film for a flat panel display of the present invention is generally bonded to an optical component for use in a flat panel display with a pressure-sensitive adhesive or an adhesive. Before bonding, the transparent plastic film substrate surface may be subjected to various surface treatments as described above.

The optical component can be, for example, a polarizer or a polarizing plate. Generally, a polarizing plate has a structure including a polarizer and a transparent protective film formed on one or both surfaces of the polarizer. If the transparent protective films are formed on both surfaces of the polarizer, respectively, the front and rear transparent protective films may be formed of the same material or different materials. Generally, in a case of a liquid crystal cell, polarizing plates are disposed on both sides of the cell. Furthermore, polarizing plates are disposed such that the absorption axes of two polarizing plates are substantially perpendicular to each other.

The antiglare film for a flat panel display of the present invention and a polarizer or polarizing plate can be laminated together with an adhesive or a pressure-sensitive adhesive and thereby a polarizing plate having the function according to the present invention can be obtained.

The polarizer is not particularly limited and various types can be used. Examples of the polarizer include: a film that is uniaxially stretched after a hydrophilic polymer film, such as a polyvinyl alcohol type film, a partially formalized polyvinyl alcohol type film, or an ethylene-vinyl acetate copolymer type partially saponified film, is allowed to adsorb dichromatic substances such as iodine or a dichromatic dye; and a polyene type oriented film, such as a dehydrated polyvinyl alcohol film or a dehydrochlorinated polyvinyl chloride film. Particularly, a polarizer formed of a polyvinyl alcohol type film and a dichromatic material such as iodine is preferred because it has a high polarization dichroic ratio. The thickness of the polarizer is not particularly limited and is, for example, about 5 to 80 μm.

A polarizer that is uniaxially stretched after a polyvinyl alcohol type film is dyed with iodine can be produced as follows. For example, a polyvinyl alcohol type film is immersed in an aqueous solution of iodine to be dyed and is then stretched by 3 to 7 times the original length. The aqueous solution of iodine may contain, for example, boric acid, zinc sulfate, or zinc chloride, if necessary. Separately, the polyvinyl alcohol type film may be immersed in an aqueous solution containing, for example, boric acid, zinc sulfate, or zinc chloride. Furthermore, before dyeing, the polyvinyl alcohol type film may be immersed in water to be washed therein if needed. Washing the polyvinyl alcohol type film with water allows soils and antiblocking agents on the polyvinyl alcohol type film surface to be washed off and also provides an effect of preventing non-uniformity, such as unevenness in dyeing, from occurring by allowing the polyvinyl alcohol type film to swell. The polyvinyl alcohol type film may be stretched after being dyed with iodine, may be stretched while being dyed, or may be dyed with iodine after being stretched. Stretching can be carried out in an aqueous solution of, for example, boric acid or potassium iodide or in a water bath.

Preferably, the transparent protective film formed on one or both surfaces of the polarizer is excellent in, for example, transparency, mechanical strength, thermal stability, moisture-blocking properties, and retardation value stability. Examples of the material for forming the transparent protective film include the same materials as those used for the aforementioned transparent plastic film substrate.

Moreover, the polymer films described in JP 2001-343529 A (WO01/37007) also can be used as the transparent protective film. The polymer films described in JP 2001-343529 A are formed of, for example, resin compositions including (A) thermoplastic resins having at least one of a substituted imide group and a non-substituted imide group in the side chain thereof and (B) thermoplastic resins having at least one of a substituted phenyl group and a non-substituted phenyl group as well as a nitrile group in the side chain thereof. Examples of the polymer films formed of the resin compositions described above include one formed of a resin composition including an acrylonitrile-styrene copolymer and an alternating copolymer containing isobutylene and N-methyl maleimide. The polymer film can be produced by extruding the resin composition in the form of a film. The polymer film has a small retardation and a small photoelastic coefficient and thus can eliminate defects such as unevenness due to distortion when it is used for a protective film of, for example, a polarizing plate. The polymer film also has low moisture permeability and thus has high durability against moisture.

From the viewpoints of, for example, polarizing properties and durability, the transparent protective film is preferably a film made of cellulose type resin such as triacetyl cellulose or a film made of norbornene type resin. Examples of commercial products of the transparent protective film include FUJITAC (trade name) (manufactured by Fuji Photo Film Co., Ltd.), ZEONOA (trade name) (manufactured by Nippon Zeon Co., Ltd.), and ARTON (trade name) (manufactured by JSR Corporation).

The thickness of the transparent protective film is not particularly limited. It can be, for example, in the range of 1 to 500 μm from the viewpoints of strength, workability such as handling properties, and thin layer properties. In the above range, the transparent protective film can mechanically protect a polarizer and can prevent a polarizer from shrinking and retain stable optical properties even when exposed to high temperature and high humidity. The thickness of the transparent protective film is preferably in the range of 5 to 200 μm and more preferably in the range of 10 to 150 μm.

The structure of a polarizing plate with the antiglare film for a flat panel display laminated therein is not particularly limited. The polarizing plate may have, for example, a structure in which the transparent protective film, the polarizer, and the transparent protective film are laminated in this order on the antiglare film for a flat panel display, or a structure in which the polarizer and the transparent protective film are laminated in this order on the antiglare film for a flat panel display.

The flat panel display of the present invention can have the same configuration as those of conventional flat panel displays except for including an antiglare film for a flat panel display of the present invention. For example, LCD, can be manufactured by suitably assembling respective components such as a liquid crystal cell, optical components such as a polarizing plate, and, if necessity, a lighting system (for example, a backlight), and incorporating a driving circuit.

Since the flat panel display of the present invention can be applied to various kinds in definition and the like, it is used for expanded applications. Non-limiting examples of the applications include office equipment such as a PC monitor, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio device, display equipment such as an information monitor for stores, security equipment such as a surveillance monitor, and nursing and medical equipment such as a monitor for nursing care and a monitor for medical use.

### EXAMPLES

Next, Examples of the present invention are described together with Comparative Examples. However, the present invention is not limited by the following Examples and Comparative Examples. Various properties in the respective Examples and Comparative examples were evaluated or measured by the following methods.

### <Refractive Index of Transparent Plastic Film Substrate and Antiglare Layer>

The refractive index of a transparent plastic film substrate and an antiglare layer was measured with an Abbe refractometer (“DR-M2/1550” (trade name), manufactured by Atago Co. Ltd.) by a measuring method specified for the apparatus. The measurement was carried out, with monobromonaphthalene being selected as an intermediate liquid, and with measuring light being allowed to be incident on the measuring planes of the film substrate and the antiglare layer.

### <Weight Average Particle Size of Fine Particles>

By the Coulter counting method, the weight average particle size of the fine particles was measured. Specifically, a particle size distribution measurement apparatus (“COULTER MULTISIZER” (trade name), manufactured by Beckman Coulter, Inc.) using a pore electrical resistance method was employed to measure electrical resistance of an electrolyte corresponding to the volume of the fine particles when the fine particles passed through the pores. Thus, the number and volume of the fine particles were measured and then the weight average particle size thereof was calculated.

### <Thickness of Antiglare Layer>

A thickness gauge of a microgauge type manufactured by Mitutoyo Corporation was used to measure the total thickness of the antiglare film. The thickness of the transparent plastic film substrate was subtracted from the total thickness. Thus, the thickness of the antiglare layer was calculated.

### <Measurement of Surface Roughness>

According to JIS B 0601 (1994 version), an average interval Sm (mm) between concaves and convexes and an arithmetic average surface roughness Ra (μm) were measured. Specifically, a glass sheet (“MICRO SLIDE GLASS”, manufactured by Matsunami Glass Ind., Ltd., with a product number of S, a thickness of 1.3 mm, and a size of 45×50 mm) was bonded to the surface of the antiglare film on which no antiglare layer had been formed, with a pressure-sensitive adhesive. Thus, a sample was prepared. A stylus type surface roughness measuring instrument having a measuring needle with curvature radius R of a tip portion (diamond) of 2 μm (a high-precision microfigure measuring instrument “SURFCORDER ET4000” (trade name), manufactured by Kosaka Laboratory Ltd.) was used to measure a surface shape of the sample in a certain direction under a condition, in which a scan rate was 0.1 mm/sec, a cut off value was 0.8 mm, and a measurement length was 4 mm. Thus, the average interval Sm (mm) between concaves and convexes and the arithmetic average surface roughness Ra (μm) were obtained. Further, an average tilt angle θa (°) was obtained from the obtained surface roughness curve. The high-precision microfigure measuring instrument automatically calculates each measurement value.

### <Total Haze Value>

A haze meter, “HM-150” (trade name) manufactured by Murakami Color Research Laboratory, was used to measure a total haze value according to haze (cloudiness) defined in JIS K 7136 (2000 version).

### <Inner Haze Value>

As shown in FIG. 4, an uneven shape of a surface of an antiglare layer 2 on a transparent plastic film substrate 1 was smoothed to make a smooth surface 4 using materials for forming the antiglare layer used in each Example and Comparative Example. An inner haze value was measured in the same manner as in the case of the total haze value. In a case where the material for forming the antiglare layer contains fine particles with a weight average particle size of 50 nm or more, the smooth surface 4 was formed using a resin that does not contain the aforementioned fine particles.

### <Surface Haze Value>

A surface haze value was measured by the following Formula.

Surface haze value=total haze value−inner haze value

### <Glare Evaluation>

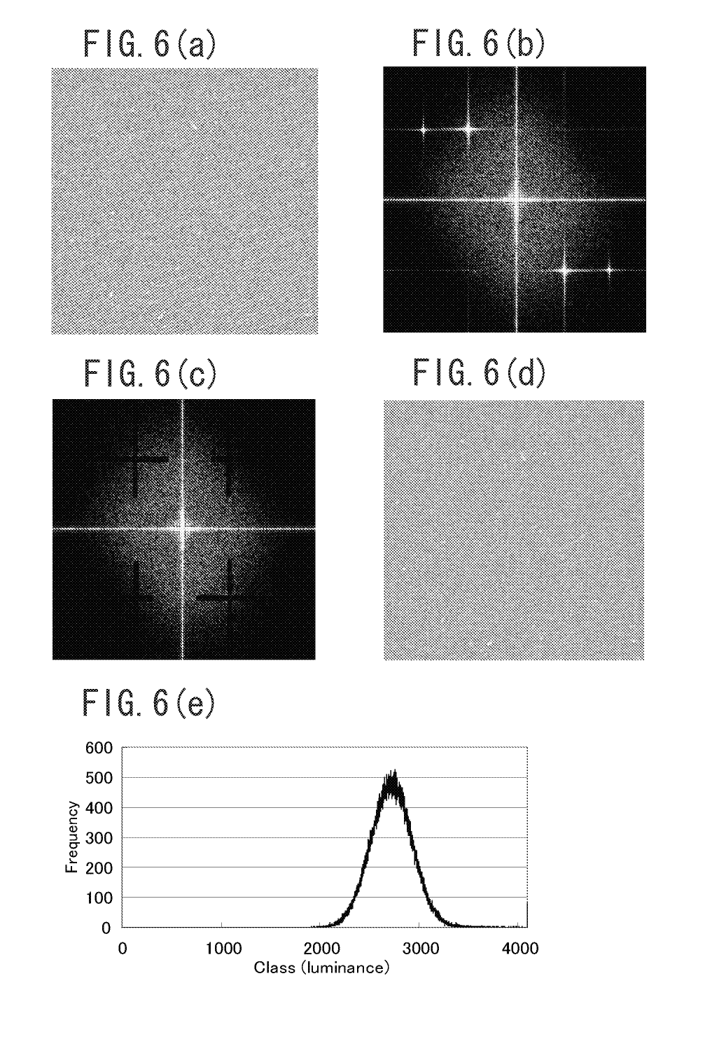

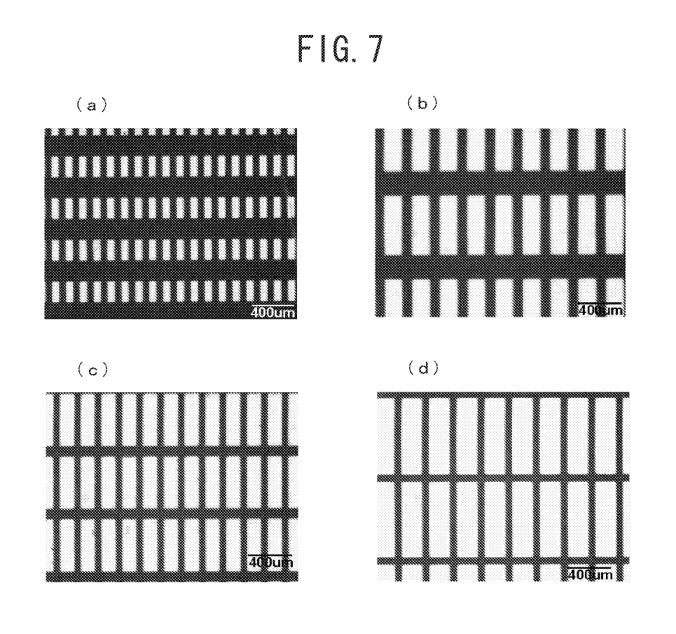

An evaluation method of glare is shown in FIG. 5. A glass sheet 41 (“MICRO SLIDE GLASS”, manufactured by Matsunami Glass Ind., Ltd., with a product number of S, a thickness of 1.3 mm, and a size of 45×50 mm) was bonded to a surface of an antiglare film 10 on which no antiglare layer had been formed, with a pressure-sensitive adhesive (not shown). Thus, a sample was obtained. This sample was set on a mask pattern 42 placed above a flat light 43 (“LIGHT-VIEWER 5700” (trade name), manufactured by Hakuba Photo Industry Co., Ltd, with an average luminance of 1000 cd/m²) in such a manner that the antiglare layer is placed uppermost. When the flat light 43 was turned on in this state, variation in luminance in a micro region was generated depending on types of the antiglare film 10 and the mask pattern 42 and the variation in luminance was recognized as glare. A photograph of this glare was taken with a digital camera 44 (“Cyber-shot DSC-H5” (trade name), manufactured by Sony Corporation) in a dark room. The photograph was taken in a condition where the distance between a surface of the antiglare film 10 and a lens of the digital camera 44 was fixed at 100 mm, the camera was focused on the surface of the antiglare film 10 by a manual focus, an image size was set at 7M, an image quality was set at fine, and an ISO sensitivity was set at automatic. Under this condition, correlatively with a visual evaluation was obtained and an error therebetween was reduced. The image hereby taken was transferred to a personal computer and analysis was carried out as follows using an image analysis software (“IMAGE PRO PLUS VER. 6.2”, manufactured by Media Cybernetics. Inc.). An example of an analysis image is shown in FIG. 6. With respect to the analysis image, 500×500 pixel in an evaluation range was specified and the image was converted into 12-bit grayscale (FIG. 6 (a)), fast Fourier transformation was carried out (FIG. 6 (b)), and a high-frequency component, which is variation in luminance derived from the mask pattern, was removed (FIG. 6 (c)). Thereafter, inverse Fourier transformation was carried out (FIG. 6 (d)) and only variation in luminance caused by the antiglare film was extracted. Then, histogram analysis of the image that had been subjected to the inverse Fourier transformation was carried out (FIG. 6 (e)) and standard deviation of the variation in luminance was defined as “a glare value”. When the glare value was 120 or lower by a visual evaluation, it was considered as an applicable level. A photograph of the mask pattern 42 used in this Example is shown in FIG. 7. As the mask pattern 42, the one with an aperture ratio (definition) of (a) 25% (212 ppi), the one with an aperture ratio (definition) of (b) 47% (106 ppi), the one with an aperture ratio (definition) of (c) 57% (143 ppi), and the one with an aperture ratio (definition) of (d) 69% (106 ppi) were used.

### <Contrast>

A polarizing plate at a viewing side of a liquid crystal cell removed from a notebook PC (“INSPIRON 630m” (trade name), manufactured by DELL, with a size of wide 17 inch) was replaced with a commercially available polarizing plate not having an antiglare film (“NPF-TEG1465DU” (trade name), manufactured by Nitto Denko Corporation). A surface of the antiglare film on which no antiglare layer had been formed was bonded to the replaced polarizing plate, with a pressure-sensitive adhesive. In a dark room, a front luminance in a black display and a white display was measured using a luminance colorimeter (“BM-5” (trade name), manufactured by Topcon Technohouse Corporation). A contrast was obtained by dividing the luminance in a white display by the luminance in a black display, and a decreasing ratio from a contrast in a condition where the antiglare film was not bonded was obtained.

### Example 1

An ultraviolet curable acrylic resin (“BEAMSET” (trade name), manufactured by Arakawa Chemical Industries Ltd.) was prepared as the material for forming the antiglare layer, and a polyethylene terephthalate (PET) film (“LUMIRROR U34” (trade name), manufactured by Toray Industries, Inc., with a thickness of 100 μm) was prepared as the transparent plastic film substrate. The material for forming the antiglare layer was applied onto one surface of the transparent plastic film substrate with a comma coater. Thus, a coating film having the thickness of 10 μm was formed. It was irradiated with an ultraviolet ray at 365 nm (with an irradiation intensity of 80 mW/cm² and an accumulative light intensity of 300 mJ/cm²) from the transparent plastic film substrate side to cure the material for forming the antiglare layer while pressing an embossing roll against a side of the transparent plastic film substrate on which the material for forming the antiglare layer had been applied. The embossing roll was manufactured such that an uneven shape of the antiglare layer after embossing satisfies Sm: 0.020 mm, Ra: 0.043 μm, θa: 1.17°. Thus, an antiglare film of Example 1 was obtained.

### Example 2

The antiglare film of Example 2 was obtained in the same manner as in Example 1 except that an embossing roll having a different surface shape was used.

### Example 3

The antiglare film of Example 3 was obtained in the same manner as in Example 1 except that an embossing roll having a different surface shape was used.

### Example 4

The antiglare film of Example 4 was obtained in the same manner as in Example 1 except that an embossing roll having a different surface shape was used.

### Example 5

The antiglare film of Example 5 was obtained in the same manner as in Example 1 except that an embossing roll having a different surface shape was used.

### Example 6

The antiglare film of Example 6 was obtained in the same manner as in Example 1 except that an embossing roll having a different surface shape was used.

### Example 7

The antiglare film of Example 7 was obtained in the same manner as in Example 1 except that an embossing roll having a different surface shape was used.

### Comparative Example 1

The antiglare film of Comparative Example 1 was obtained in the same manner as in Example 1 except that an embossing roll having a different surface shape was used.

### Comparative Example 2

The antiglare film of Comparative Example 2 was obtained in the same manner as in Example 1 except that an embossing roll having a different surface shape was used.

### Comparative Example 3

An ultraviolet curable resin composed of isocyanurate triacrylate, pentaerythritol triacrylate, dipentaerythritol hexaacrylate, and isophorone diisocyanate polyurethane was prepared. The cured film of the ultraviolet curable resin had a refractive index of 1.53. 0.5 parts by weight of leveling agent (DEFENSA MCF323 (trade name), manufactured by Dainippon Ink and Chemicals, Incorporated), 14 parts by weight of polystyrene particles (“Chemisnow SX350H” (trade name), manufactured by Soken chemical & Engineering Co., Ltd., with a weight average particle size of 3.5 μm and a refractive index of 1.59), and 5 parts by weight of photopolymerization initiator (“IRGACURE 184” (trade name), manufactured by Ciba Specialty Chemicals), per 100 parts by weight of resin solid content of the ultraviolet curable resin were dissolved or dispersed in a mixed solvent (toluene:butyl acetate:ethyl acetate=86.5:1.0:12.5 (weight ratio)) so that the solid concentration was 45% by weight. Thus, a material for forming an antiglare layer of Comparative Example 3 was prepared.

A triacetyl cellulose film (“TD80UL” (trade name), manufactured by Fuji Film Co., Ltd., with a thickness of 80 μm and a refractive index of 1.48) was prepared as a transparent plastic film substrate. The material for forming the antiglare layer was applied to one surface of the transparent plastic film substrate with a comma coater. Thus, a coating film was formed. Subsequently, it was heated at 100° C. for 1 minute and thus the coating film was dried. Thereafter, it was irradiated with an ultraviolet ray at 365 nm (with an irradiation intensity of 80 mW/cm² and an accumulative light intensity of 300 mJ/cm²) using a metal halide lamp from the coating film side and thereby the coating film was cured to form a 5-μm thick antiglare layer. Thus, an antiglare film of Comparative Example 3 was obtained.

### Comparative Example 4

A resin containing the following component (“GRANDIC PC1097” (trade name), manufactured by Dainippon Ink and Chemicals, Incorporated, with a solid content of 66% by weight) was prepared. The cured film of the resin had a refractive index of 1.53. 20 parts by weight of acrylic particles (“SSX-108TNL” (trade name), manufactured by Sekisui Plastics Co., Ltd., with a weight average particle size of 8 μm and a refractive index of 1.495) and 0.1 parts by weight of leveling agent (“GRANDIC PC-F479” (trade name), manufactured by Dainippon Ink and Chemicals, Incorporated), per 100 parts by weight of resin solid content of the aforementioned resin were mixed. This mixture was diluted with acetic ether such that the solid concentration was 55% by weight. Thus, a material for forming an antiglare layer of Comparative Example 4 was obtained.

Isophorone diisocyanate urethane acrylate (100 parts by weight)

Dipentaerythritol hexaacrylate (38 parts by weight)

Pentaerythritol tetraacrylate (40 parts by weight)

Pentaerythritol triacrylate (15.5 parts by weight)

Polymer or copolymer having a repeating unit represented by the following general formula (1), or a mixture of the polymer and copolymer (30 parts by weight)

Photopolymerization initiator: 1.8 parts by weight of “IRGACURE 184” (trade name, manufactured by Ciba Specialty Chemicals) and 5.6 parts by weight of Lucirin type photopolymerization initiator

Mixed solvent; butyl acetate:ethyl acetate=3:4 (weight ratio)

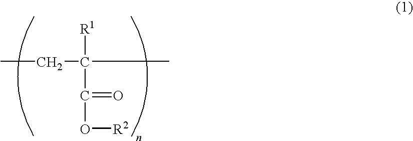

In formula (1), R¹ denotes —H or —CH₃, R² denotes —CH₂CH₂OX or a group that is represented by the following general formula (2), and X denotes —H or an acryloyl group that is represented by the following general formula (3).

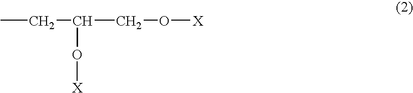

In general formula (2), X denotes —H or an acryloyl group that is represented by the following general formula (3), and the Xs may be identical to or different from each other.

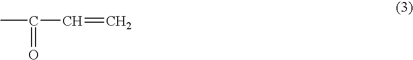

A triacetyl cellulose film (“TD80UL” (trade name), manufactured by Fuji Film Co., Ltd., with a thickness of 80 μm and a refractive index of 1.48) was prepared as a transparent plastic film substrate. The material for forming the antiglare layer was applied to one surface of the transparent plastic film substrate with a comma coater. Thus, a coating film was formed. Subsequently, it was heated at 100° C. for 1 minute and thus the coating film was dried. Thereafter, it was irradiated with an ultraviolet ray at 365 nm (with an irradiation intensity of 80 mW/cm² and an accumulative light intensity of 300 mJ/cm²) using a high pressure mercury lamp from the coating film side, and thereby the coating film was cured to form a 24-μm thick antiglare layer. Thus, an antiglare film of Comparative Example 4 was obtained.

With respect to each antiglare film of Examples 1 to 7 and Comparative Examples 1 to 4 thus obtained, various properties were measured. The results are indicated in Table 1 below.

TABLE 1

| | | | | | | | Glare Value | | | | | |
|---|---|---|---|---|---|---|---|---|---|---|---|---|
| | Sm | Ra | θa | Total Haze | Surface Haze | Inner Haze | (Aperture Ratio) | | | | Contrast | A Calculation |
| | (mm) | (μm) | (deg) | (%) | H(%) | (%) | 25% | 47% | 57% | 69% | Decreasing Ratio (%) | Value* |
| Example 1 | 0.020 | 0.043 | 1.17 | 5.4 | 5.1 | 0.3 | 112.3 | 88.4 | 73.7 | 67.2 | 6.1 | >24.5 |
| Example 2 | 0.035 | 0.061 | 1.36 | 5.6 | 5.4 | 0.2 | 128.5 | 100.7 | 87.9 | 76.0 | 6.3 | >30.1 |
| Example 3 | 0.042 | 0.063 | 1.39 | 6.1 | 5.7 | 0.4 | 141.1 | 109.4 | 82.7 | 79.5 | 7.0 | >32.7 |
| Example 4 | 0.051 | 0.062 | 1.01 | 3.4 | 3.1 | 0.3 | 148.2 | 114.7 | 94.5 | 83.3 | 3.6 | >37.5 |
| Example 5 | 0.086 | 0.097 | 0.82 | 1.5 | 1.2 | 0.3 | 168.4 | 131.1 | 112.3 | 96.2 | 7.0 | >52.0 |
| Example 6 | 0.097 | 0.172 | 1.53 | 6.1 | 5.7 | 0.4 | 175.9 | 137.6 | 114.3 | 101.9 | 7.0 | >53.8 |
| Example 7 | 0.154 | 0.273 | 1.68 | 6.5 | 6.1 | 0.4 | 229.0 | 199.4 | 148.9 | 121.8 | 7.5 | >75.5 |
| Comparative | 0.036 | 0.119 | 3.31 | 26.2 | 25.9 | 0.3 | 121.1 | 96.3 | 84.9 | 70.9 | 37.2 | >19.3 |
| Example 1 | | | | | | | | | | | | |
| Comparative | 0.086 | 0.374 | 3.94 | 24.9 | 24.6 | 0.3 | 140.4 | 113.1 | 94.2 | 80.4 | 32.5 | >39.3 |
| Example 2 | | | | | | | | | | | | |
| Comparative | 0.097 | 0.172 | 1.53 | 40.7 | 6.1 | 34.6 | 105.1 | 83.0 | 67.5 | 63.8 | 53.0 | >53.6 |
| Example 3 | | | | | | | | | | | | |
| Comparative | 0.110 | 0.104 | 0.82 | 21.1 | 3.0 | 18.1 | 129.0 | 100.9 | 82.1 | 74.6 | 26.0 | >60.3 |
| Example 4 | | | | | | | | | | | | |

*A(%) > (100Sm(mm) − 0.142H(%) + 5.1)/0.26

As indicated in Table 1 above, in Examples, in an aperture ratio range calculated by the Formula (1), antiglare films whose glare value was small as well as decrease in contrast was small were obtained. In contrast, in Comparative Examples, the glare value was small in the aperture ratio range calculated by the Formula (1). However, since the total haze value is large, only antiglare films with a remarkable decrease in contrast, i.e., antiglare films whose contrast is decreased by 26% or more, were obtained. Accordingly, in Comparative Examples, it was not possible to achieve both prevention of glare and maintenance of contrast.

The antiglare film for a flat panel display of the present invention makes it possible to solve all the contradictory problems in improving contrast, ensuring antiglare properties, preventing white blur, and providing high definition. Accordingly, the antiglare film for a flat panel display of the present invention can be used suitably, for example, for optical elements such as polarizing plates as well as image displays such as liquid crystal panels and LCDs. It has no limitation in application and is applicable across a wide field.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A flat panel display including an antiglare film at a viewing side surface thereof,
wherein the flat panel display includes a black matrix pattern,
wherein a total haze value is 15 or less, wherein the total haze value is a haze value (cloudiness) (%) of whole antiglare film based on JIS K 7136 (2000 version), and
wherein an aperture ratio A (%) of the black matrix pattern, an average interval Sm (mm) between concaves and convexes of a surface of the antiglare film, and a surface haze H (%) satisfy a relationship of the following Formula (1):
A>(100Sm−0.142H+5.1)/0.26 (1)
wherein
the average interval Sm is an average interval (mm) between concaves and convexes of surface measured according to JIS B 0601 (1994 version);
Surface haze H is the total haze value−an inner haze value; and
the inner haze value is a haze value of whole antiglare film measured in a case where the surface of antiglare film is smoothed.

2. The flat panel display according to claim 1, wherein the antiglare film does not contain fine particles with a weight average particle size of 50 nm or more.

3. The flat panel display according to claim 1, wherein a decreasing ratio of a contrast of the flat panel display relative to a contrast of the flat panel display measured after removing the antiglare film therefrom is less than 10%.

4. The flat panel display according to claim 1, wherein the Sm (mm) of the antiglare film is in a range of 0.01<Sm<0.5.

5. The flat panel display according to claim 1, wherein the following Ra (μm) of the antiglare film is in a range of 0.01<Ra<0.5
Ra: arithmetic average surface roughness (μm) defined in JIS B 0601 (1994 version).

6. The flat panel display according to claim 1, wherein an uneven shape of the surface of the antiglare film is formed by embossing.

7. An antiglare film for attachment to a viewing side surface of a flat panel display,
wherein the flat panel display includes a black matrix pattern,
wherein a total haze value is 1.5 or less, wherein the total haze value is a haze value (cloudiness) (%) of whole antiglare film based on JIS K 7136 (2000 version), and
wherein an aperture ratio A (%) of the black matrix pattern, an average interval Sm (mm) between concaves and convexes of a surface of the antiglare film, and a surface haze H (%) are designed so as to satisfy a relationship of the following Formula (1):
A>(100Sm−0.142H+5.1)/0.26 (1)
wherein
the average interval Sm is an average interval (mm) between concaves and convexes of surface measured according to JIS B 0601 (1994 version);
the Surface haze H is the total haze value−an inner haze value; and
the inner haze value is a haze value of whole antiglare film measured in a case where the surface of antiglare film is smoothed.

8. The antiglare film for a flat panel display according to claim 7, wherein the antiglare film does not contain fine particles with a weight average particle size of 50 nm or more.

9. The antiglare film for a flat panel display according to claim 7, wherein the Sm (mm) of the antiglare film is in a range of 0.01<Sm<0.5.

10. The antiglare film for a flat panel display according to claim 7, wherein the following Ra (μm) of the antiglare film is in a range of 0.01<Ra<0.5
Ra: arithmetic average surface roughness (μm) defined by JIS B 0601 (1994 version).

11. The antiglare film for a flat panel display according to claim 7, wherein an uneven shape of the surface of the antiglare film is formed by embossing.

12. A flat panel display comprising an antiglare film at a viewing side surface thereof,
wherein the antiglare film is an antiglare film for a flat panel display according to claim 7.
